(19) United States
(12) Patent Application Publication
(10) Pub. No.: US 2023/0286486 A1
(43) Pub. Date: Sep. 14, 2023

(54) Device for Direct Force Measurement

(71) Applicant: Methode Eletronics Malta Ltd., Birkirkara (MT)

(72) Inventors: Alexander Galea, Dingli (MT); Johannes Gießibl, Amerang (DE); Julius Beck, Munich (DE); Paul Sinclair, Andechs (DE)

(21) Appl. No.: 18/115,128

(22) Filed: Feb. 28, 2023

(30) Foreign Application Priority Data
Mar. 8, 2022 (DE) 102022105427.6

(51) Int. Cl. B60T 17/22; G01L 5/28; G01L 5/169; F16D 66/00

(52) U.S. Cl. CPC B60T 17/22; G01L 5/28; G01L 5/169; F16D 66/00; F16D 2066/005; F16D 55/22

(57) ABSTRACT

Device for measuring at least one first force (19) generated within a brake system (20) of a vehicle (9). The brake system (20) comprises at least caliper (16) and at least one brake disc (4). The at least two load pins (12, 13), connecting the caliper (16) and the vehicle (9) are arranged to measure the first force (19). A converting means (21) is arranged to convert a basic force (22) into the first force (19) to be measured.

### RELATED APPLICATION DATA

This application claims priority benefit to German Patent Application serial no. DE 10 2022 105 427.6 filed on Mar. 8, 2022, the disclosure of which is incorporated by reference herein.

### DESCRIPTION

The patent application refers to a device for direct force measurement.

### STATE OF THE ART

State of the art systems are frequently based on an indirect measurement to determine the brake force. In other known systems, the measurement is based on mathematical calculations.

State of the art systems are commonly based on the measurement of the energy used to generate the required braking force. Wherein the required braking force may be generated by means of electrical energy or pneumatically or using hydraulic pressure.

### Problem

Many state of the art systems often prove to be inaccurate or time-consuming.

Therefore, it is the objective of the invention to provide a device for measuring the force acting on the brake caliper.

### Solution to the Problem

The problem is solved by a converting means, which is arranged to convert a basic force into a first force, which is then measured.

### Brake System

According to the invention the brake system comprises one or more of the following components: At least one brake caliper, at least one brake pad and/or a brake shoe. At least one brake piston is also included in the brake system. The brake system also comprises at least one brake disc.

The components of the brake system are referred to in more detail below.

A brake system is referred to as a mechanical device that prevents movement by absorbing energy from a moving system.

The brake system is used to slow or stop a moving vehicle. Also, a wheel or an axle of the vehicle may be slowed or stopped.

The brake system preferably reduces or stops the movement by generating friction.

In the following the brake system is described in relation to a land-based vehicle. Also, the brake system is referred to as brake.

### Brake Caliper

The invention understands the brake caliper to be an assembly that houses at least one of the brake pads and the brake pistons.

Generally, the caliper may be designed as a floating caliper. Alternatively, the caliper may be designed as fixed caliper. Opposite to the floating caliper, the fixed caliper does not move relative to the brake disc. Therefore, the fixed caliper is less tolerant of disc unevenness.

The floating caliper moves with respect to the brake disc. The floating caliper may move along a line parallel to an axis of rotation of the brake disc.

### Indirect Measurement Versus Direct Measurement

### Indirect Measurement

State of the art systems are frequently designed as indirect measurement systems. The indirect measurement systems usually measure the energy source that is used to create the required brake force.

By way of example, the required braking force may be generated by means of electrical energy or pneumatically or using hydraulic pressure.

The invention is described in more detail below with reference to a hydraulic brake system.

In the case of a hydraulic brake system, the energy that would be required to generate a certain braking force could be determined, for example, by determining the force that would be required to generate the required hydraulic pressure.

### Direct Measurement

A direct measurement of the energy required to provide a specific braking force may be taken when one explicitly measures the characteristic of the object in question.

By way of example, the energy used to provide a certain braking force with the brake system, preferably using a brake disc, can be measured directly at the brake shoe and/or at the brake pad.

As an example, but in no way exclusively, a brake force (P_{B}) in Watts (unit: W) can be determined at the brake shoe by multiplying the tangential braking force (F_{B}) at the brake shoe of the brake system in Newton (unit: N) with the speed (v) between the brake shoes in metres per second (unit: meter/second).

The corresponding formula would be:

(P_{B})=(F_{B})*V

It goes without saying that the required braking energy may also be determined in another technical way.

The invention proves to be very advantageous because the load pins according to the invention provide useful information about the degree of effectiveness of the braking force provided to perform the braking operation.

The degree of effectiveness refers to the braking force provided between the vehicle and the road surface.

Contrary to the invention, state of the art solutions only measure the force between the caliper and the brake disc.

A force, preferably a brake force can be measured in a direct manner by determining the reactive force.

The reactive force is always present to obtain the equilibrium of forces.

### Reactive Force

The invention understands the reactive force to be a force that acts in the opposite direction to an active force.

In the example of a hydraulic disk brake system, the braking force is applied to the brake shoes of the hydraulic brake system to exert the required braking torque on the brake disc. Thus, in the hydraulic brake system, the reactive force is the force needed to generate the required hydraulic pressure for the required braking force.

For every force there is an oppositely directed reactive force of the same magnitude.

Depending on the mechanical setup of the individual system, the reactive force may be one of the following types:

The reactive force may be a torque. The reactive force may also be a shear force. Of course, there may also be an axial reactive force or any other force.

### Torque

The invention understands the term torque to be a rotational equivalent of linear force. The torque may also be referred to as moment. The torque may further be referred to as moment of force or as a rotational force. Alternatively, the torque may be understood as a turning effect. According to the invention the torque represents the capability of a force to produce change in the rotational motion of a body.

As an example, the torque may be caused by a lever arm. Thus, a linear reactive force is converted to a torque moment. The torque moment is measured by means of the magnetoelastic force sensor referred to below.

The magnetoelastic force sensor may be a torque sensor.

### Shear Force

According to the invention, shear forces represent unaligned forces pushing one part of a body in one specific direction. Whereas another part of the body is pushed in the opposite direction.

According to the invention a braking force may be transferred via pins. The braking force may be measured with a magnetoelastic force sensor, wherein the magnetoelastic force sensor may be designed as a shear force sensor.

### Axial Force

Alternatively, the reactive force may be an axial force.

An axial force refers to a reverse tensile force or to a reverse tensile pressure on a certain cross section of a structure. The axial force is caused by a certain action.

When the reverse tensile force is located at the centre of gravity of the cross section, it is called axial force, wherein the magnetoelastic force sensor may be designed as an axial force sensor.

Any reactive force referred to above may by measured by means of a magnetoelastic force sensor that is discussed in more detail below.

### Magnetoelastic Force Sensor

The magnetoelastic force sensor is designed to measure at least one force. The force, measured by the magnetoelastic force sensor may be torque. However, it goes without saying that the magnetoelastic force sensor may also be designed to measure a force, other than torque.

According to the invention, the magnetoelastic force sensor comprises a ferromagnetic ring that is attached to a shaft, with the shaft being measured by the sensor.

Alternatively, the shaft may comprise a ferromagnetic material. Wherein a section of the shaft may be permanently magnetized. The magnetized section of the shaft may produce a circumferential magnetic field, eliminating the need for an external ring.

Thus, a magnetoelastic force sensor is based on the magnetoelastic effect. According to the invention, the magnetoelastic force sensor uses non-contact sensing to provide accurate torque measurements for rotating or stationary shafts.

According to the invention the magnetized section may also be arranged on geometrical object other than the shaft referred to above.

According to the invention, the ferromagnetic ring can also be arranged on another geometrical body, except on a ring.

### DESCRIPTION OF THE DRAWINGS

Further examples and advantageous embodiments of the invention are described in more detail below with reference to the figures.

FIG. 1, shows a schematic view of a brake piston with brake pad and a brake disc,

FIG. 2 shows a schematic view of a reactive force in relation to a lever arm,

FIG. 3 shows a shaft with magnetisations in the area of sensing coils,

FIG. 4 shows the influence of a reactive linear force on a shear area,

FIG. 5 shows a load pin with a magnetisation,

FIG. 6 shows a brake disk of a vehicle,

FIG. 7 shows a brake disk in rotation,

FIG. 8 shows one arrow indicating the braking torque and another arrow representing the corresponding reactive force,

FIG. 9 shows axial reactive forces running in the opposite direction with respect to an imaginary axis and

FIG. 10 shows a wheel of a vehicle comprising the caliper and the load pins.

### DETAILED DESCRIPTION

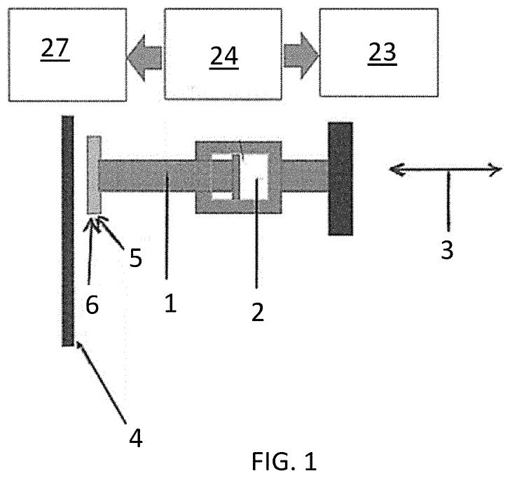

FIG. 1 shows a brake piston 1 that is arranged in a brake cylinder 2. A brake pedal (not shown) generates a fluid pressure in the hydraulic fluid in a brake cylinder 2.

When the fluid pressure is further increased in the brake cylinder 2 the compressed hydraulic fluid pushes the brake piston 1 along a longitudinal axis 3 towards the brake disc 4.

A brake pad 5 is arranged at the front end 6 of the brake piston 1.

With an additional increase of the fluid pressure in the brake cylinder 2, the brake pad 5 is pressed against the brake disc 4 and thus the braking process is initiated (not shown).

The force 24 that pushes the brake piston 1 along the longitudinal axis 3 towards the brake disc 4 is generated within the brake cylinder 2.

A force 27 applying the brake pad 5 to the brake disc 4 extends along the longitudinal axis 3.

The force 24 that pushes the brake piston 1 along a longitudinal axis 3 towards the brake disc 4 coincides with the force 27 that presses the brake pad 5 against the brake disc 4. The reactive force, which represents a balance of forces with respect to the force 24 pushing the brake piston 1 along the longitudinal axis 3 and/or with respect to the force 27 pressing the brake pad 5 against the brake disc 4, is represented by the reference numeral 23.

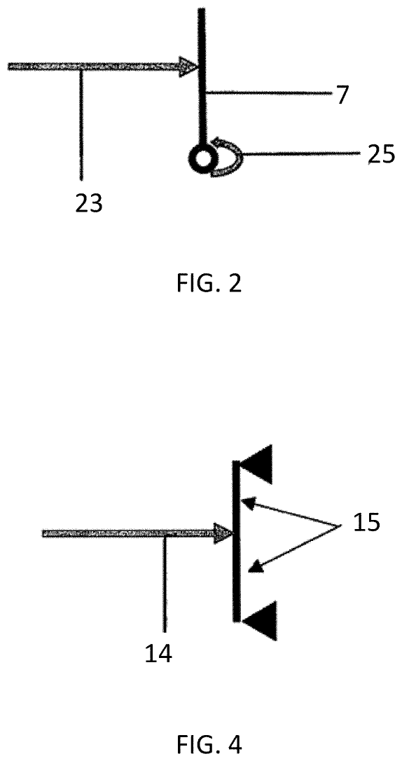

FIG. 2 shows a schematic view of a reactive force 23 in relation to a lever arm 7. The reactive force 23 shown in FIG. 2 is a linear reactive force 23.

The lever arm 7 rotates around an axis of rotation, generating a torque moment 25.

In the illustration of FIG. 2, the reactive force 23 acts at a right angle on the lever arm 7.

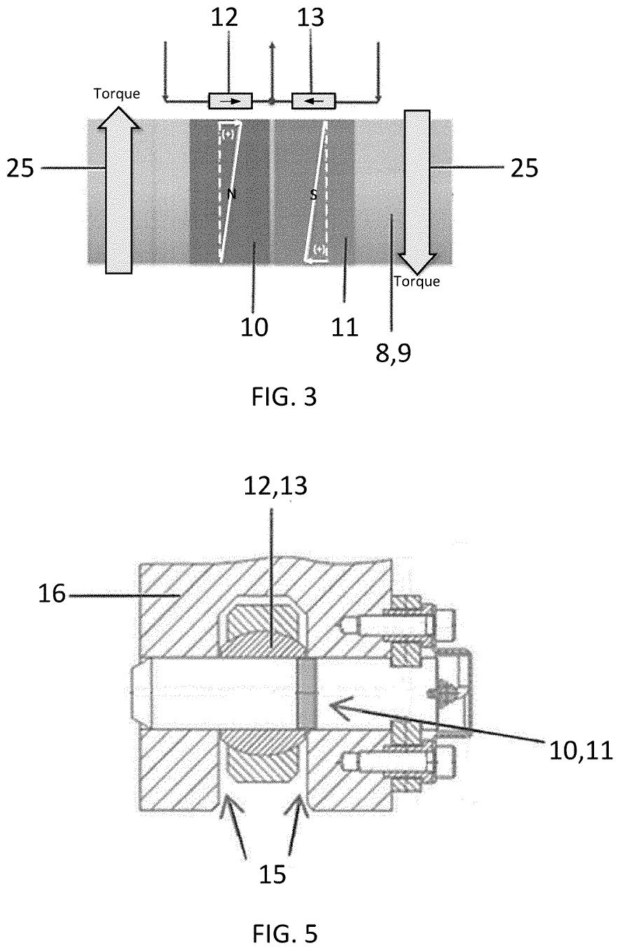

The FIG. 3 shows a magnetoelastic torque sensor. The magnetoelastic torque sensor depicted in FIG. 3 shows how the linear force converted into the torque force, referred to in FIG. 2, is measured.

In FIG. 3 sensing coils of the torque sensor are represented by reference 12 and 13.

FIG. 4 shows the influence of a reactive linear force 14 on a shear area 15.

FIG. 5 shows a load pin 12, 13 with a magnetisation 10, 11. The load pin 12, 13 is arranged on a caliper 16. The load pin 12, 13 has shear areas opposite the caliper 16.

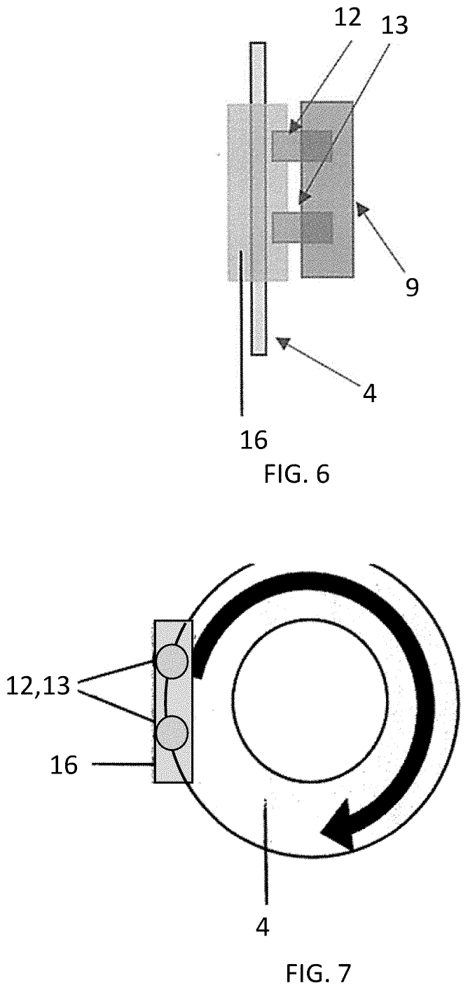

FIG. 6 shows a brake disk 4 of a vehicle 9. The caliper 16 is located above the brake disk 4. In the FIG. 6 magnetoelastic shear force sensors are represented by reference 12, 13. The magnetoelastic shear force sensors 12, 13 connect the brake disk 4 to the vehicle 9.

FIG. 7 shows a brake disk 4 in rotation. The caliper 16 is located in the area of the brake disk 4. The load pins 12, 13 can be seen arranged in the caliper 16.

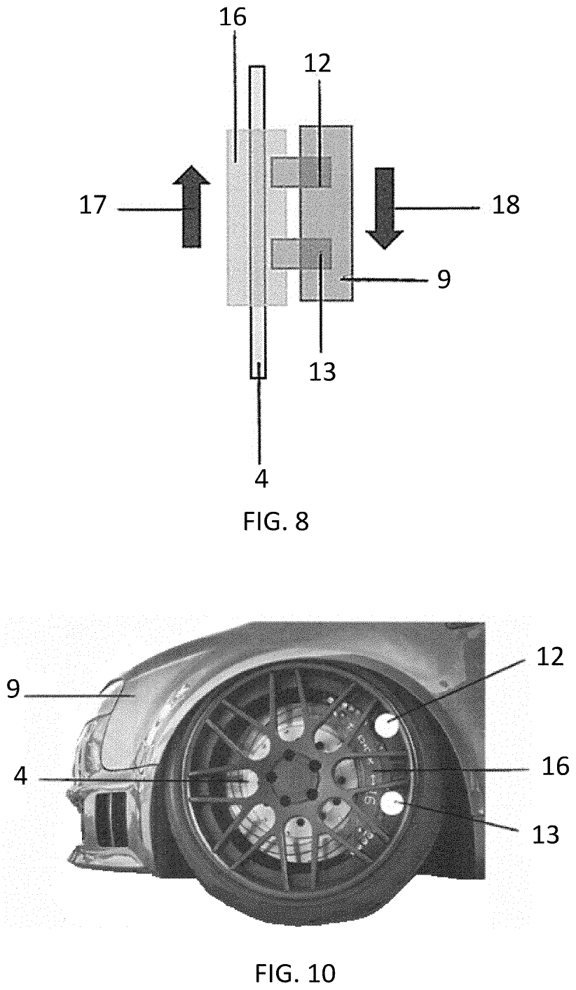

FIG. 8 is similar in construction to FIG. 6, the difference being that in FIG. 8 arrows 17 and 18 are shown. The arrow 17 indicates the braking torque, applying the brake pad 5 (not shown) to the brake disc 4, being converted into a linear force. On the other hand, the arrow 18 represents the reactive force facing in the opposite direction.

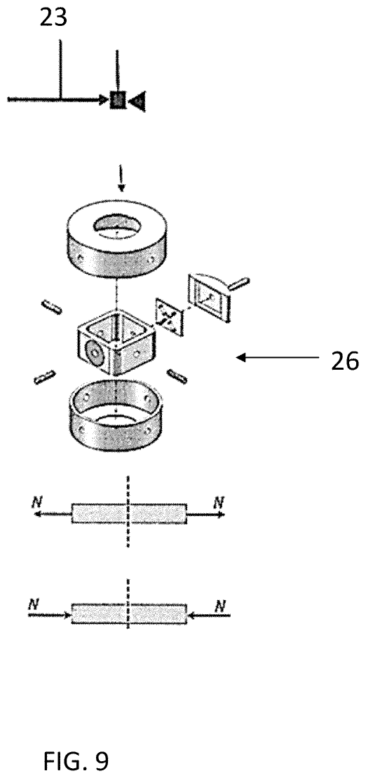

In the illustration in FIG. 9, axial reactive forces run in the opposite direction with respect to an imaginary axis.

FIG. 10 shows a wheel of a vehicle 9. The brake disc 4 is arranged in the centre of the wheel.

The caliper 16 is positioned above the brake disc 4.

In the illustration of FIG. 10, the load pins 12, 13 are arranged above the caliper 16.

### LIST OF REFERENCES

1 brake piston
2 brake cylinder
3 longitudinal axis
4 brake disc
5 brake pad
6 front end
7 lever arm
8 shaft
9 vehicle
10 band of magnetisation
11 band of magnetisation
12 load pin
13 load pin
14 reactive linear force
15 shear area
16 caliper
17 arrow
18 arrow
19 first force
20 brake system
21 converting means
22 basic force
23 reactive force
24 force pushing the brake pad
25 torque force
26 magnetoelastic torque sensor
27 force applying the brake pad to the brake disc
28 magnetoelastic shear force
29 converting pin
30 linear shear force

1. A device for measuring at least one first force (19) generated within a brake system (20) of a vehicle (9), characterized in that the brake system (20) comprises:
at least one caliper (16), and
at least one brake disc (4)
wherein at least two load pins (12, 13) connect the caliper (16) and the vehicle (9) and the at least two load pins (12,13) are arranged to measure the first force (19); and
wherein a converting means (21) is arranged to convert a basic force (22) into the first force (19) to be measured.

2. The device according to claim 1 characterized in that the converting means (21) converts a linear reactive force (23) as a basic force (22) to a torque moment (25) as the first force (19).

3. The device according to claim 2 characterized in that the load pin (12, 13) is a magnetoelastic shear force sensor (26).

4. The device according to claim 1 characterized in that the converting means (21) converts a linear reactive force (23) as a basic force (22) to shear force as the first force (19).

5. The device according to claim 4 characterized in that the load pin (12, 13) is a magnetoelastic shear sensor.

6. The device according to claim 4 characterized in that the converting means (21) is a converting pin (29).

7. The device according to claim 6 characterized in that the converting means (21) converts a braking torque as a basic force (22) to a linear shear force (30) as the first force (19).

8. The device according to claim 1 characterized in that the load pin (12, 13) is a magnetoelastic torque sensor (26).
